(19) United States
(12) Patent Application Publication
(10) Pub. No.: US 2022/0267064 A1
(43) Pub. Date: Aug. 25, 2022

(54) Systems and Methods for Tamper-Resistant Securing Device for a Container

(71) Applicant: Quantum X LLC, Sheboygan Falls, WI (US)

(72) Inventors: John M. Gonnering, Sheboygan, WI (US); Paul M. Gonnering, Sheboygan Falls, WI (US); Richard H. Yinko, JR., Sheboygan, WI (US)

(21) Appl. No.: 17/182,904

(22) Filed: Feb. 23, 2021

(51) Int. Cl. B65D 55/02; A61J 1/14; B65D 33/16; B65D 33/34; B65B 5/06; B65B 7/16; G06Q 10/08

(52) U.S. Cl. CPC B65D 55/028; A61J 1/1437; B65D 33/1666; B65D 33/34; B65B 5/06; B65B 7/16; G06Q 10/087; A61J 2205/10

(57) ABSTRACT

In some embodiments, systems and methods for a tamper-resistant securing device for use with a closeable container include a housing assembly, a lock member, and an identifier. The housing assembly can be configured to be moved from a sealed configuration to an unsealed configuration. The lock member can be at least partially enclosed within the housing assembly and the lock member can be configured to be moved between an unlocked orientation and a locked orientation. The identifier can be accessible when the lock member is in the locked orientation. The housing assembly and the lock member are configured to inhibit or permit movement of the lock member based on the sealed or unsealed configuration of the housing assembly.

### CROSS-REFERENCE TO RELATED APPLICATIONS

Not applicable.

### STATEMENT REGARDING FEDERALLY SPONSORED RESEARCH

Not applicable.

### BACKGROUND

A variety of goods, such as food and medicine, are commonly transferred between multiple parties, such as from a seller to a consumer. In some cases, such goods may be handled by an intermediate carrier, such as an employee of a food delivery service, for example. Often, a carrier provides the consumer with a degree of tracking so that the consumer has an indication of where the good is located during transit. In many applications, it may be useful to provide a tamper-resistant system and method for transporting goods that allows a carrier to indicate to, for instance, a consumer and/or a delivery service when the goods have been picked up, are in transit, and are delivered. Such tamper-resistant systems and methods may also ensure that the goods were not handled or compromised during transit.

Therefore, it may be generally useful to provide a tamper-resistant system and method of transporting goods between parties.

### SUMMARY

Some embodiments described herein provide a tamper-resistant securing device for use with a closeable container. The tamper-resistant securing device can include a housing assembly, a lock member, and an identifier. The housing assembly can be configured to be movable from a sealed configuration to an unsealed configuration. The lock member can be at least partially enclosed within the housing assembly and configured to be movable between an unlocked orientation and a locked orientation. The identifier can be associated with at least one of the housing assembly and the lock member, and can be configured to be accessible when the lock member is in the locked orientation. When the housing assembly is in the sealed configuration and the lock member is in the unlocked orientation, the housing assembly and the lock member can be configured to permit the lock member to move from the unlocked orientation to the locked orientation. When the housing assembly is in the sealed configuration and the lock member is in the locked orientation, the housing assembly and the lock member can be configured to inhibit the lock member from moving from the locked orientation to the unlocked orientation. When the housing assembly is in the unsealed configuration and the lock member is in the locked orientation, the housing assembly and the lock member can be configured to permit the lock member to move from the locked orientation to the unlocked orientation.

In some embodiments, a tamper-resistant securing device can include an identifier that is not accessible when a lock member is in an unlocked orientation.

In some embodiments, a tamper-resistant securing device can include a lock member that is slidable relative to a housing.

In some embodiments, a tamper-resistant securing device can include a lock member that includes a recess and a housing assembly that includes a tooth. The tooth can be engaged with the recess when the lock member is in a locked orientation and the housing assembly is in a sealed configuration.

In some embodiments, a tamper-resistant securing device can include a tooth that is disengaged from a recess when a housing assembly is in an unsealed configuration.

In some embodiments, a tamper-resistant securing device can include an identifier that is disposed on a proximal end of a lock member.

In some embodiments, a tamper-resistant securing device can include a housing assembly. The housing assembly can include a handle portion.

In some embodiments, a tamper-resistant securing device can include a housing assembly that is configured such that the housing assembly is deformed when moved from the sealed configuration to the unsealed configuration.

In some embodiments, a tamper-resistant securing device can include a housing assembly that includes a first housing portion and a seal portion. The seal portion can be configured to be separated from the first housing portion along lines of material weakness when the housing assembly is moved to an unsealed configuration.

In some embodiments, a tamper-resistant securing device can include a lock member that includes an actuation portion engageable to move a lock member between an unlocked orientation and a locked orientation.

In some embodiments, a tamper-resistant securing device can include a housing assembly that includes a first housing portion and a tube. A lock member of the tamper-resistant securing device can include a tongue that is dimensioned to be received by the tube.

Some embodiments of the invention provide a method of selectively securing goods within a container having a closeable opening with a tamper-resistant securing device. The method can include securing the opening of the container via a lock member and a housing assembly of the tamper-resistant securing device, moving the lock member into a locked orientation to inhibit opening of the container without moving the housing assembly from a sealed configuration to an unsealed configuration, and revealing an identifier accessible after moving the lock member into the locked orientation.

In some embodiments, a method of selectively securing goods within a container having a closeable opening with a tamper-resistant securing device can include moving a lock member of the tamper-resistant securing device into a locked orientation. Moving the lock member into a locked orientation can include sliding the lock member relative to a housing assembly so that a tooth of the housing assembly engages a recess of the lock member and the lock member is prevented from sliding in an opposing direction.

In some embodiments, a method of selectively securing goods within a container having a closeable opening with a tamper-resistant securing device can include scanning an identifier of the tamper-resistant securing device.

In some embodiments, a method of selectively securing goods within a container having a closeable opening with a tamper-resistant securing device can include unsealing a single-use seal portion from a housing assembly of the tamper-resistant securing device to unlock a lock member and access the goods within the container.

In some embodiments, a method of selectively securing goods within a container having a closeable opening with a tamper-resistant securing device can include unsealing a single-use seal portion of the tamper-resistant securing device by pulling the single-use seal portion at a pull tab that extends away from a housing assembly.

Some embodiments of the invention provide a method of delivering goods using a tamper-resistant securing device. The method can include receiving an order for a good in a platform, preparing the order at a preparation site, inserting the good into a container, applying a tamper-resistant securing device to an opening of the container, securing the tamper-resistant securing device in a locked orientation to reveal an identifier, and pairing the identifier with the platform at the preparation site.

In some embodiments, a method of delivering goods using a tamper-resistant securing device can include pairing an identifier with a platform at a preparation site. Pairing the identifier with the platform at the preparation site can notify a courier that the container is ready for transit.

In some embodiments, a method of delivering goods using a tamper-resistant securing device can include transporting a container and the tamper-resistant securing device to a receiving site and pairing an identifier with a platform at the receiving site.

In some embodiments, a method of delivering goods using a tamper-resistant securing device can include pairing an identifier with a platform at a preparation site. Pairing the identifier with the platform at the preparation site can include sending an alert to a receiving site.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an exploded isometric view of a tamper-resistant securing device according to an embodiment of the invention.

FIG. 2 is an inner isometric view of a first housing portion of the tamper-resistant securing device of FIG. 1.

FIG. 3 is an outer isometric view of the first housing portion of FIG. 2 in a sealed configuration.

FIG. 4 is an outer isometric view of the first housing portion of FIG. 2 in an unsealed configuration.

FIG. 5 is an inner isometric view of a second housing portion of the tamper-resistant securing device of FIG. 1.

FIG. 6 is an outer isometric view of the second housing portion of FIG. 5.

FIG. 7 is a side view of a tongue member of the tamper-resistant securing device of FIG. 1.

FIG. 8 is a front isometric view of a trigger portion of the tongue member of FIG. 7.

FIG. 9 is a rear isometric view of the trigger portion of the tongue member of FIG. 7.

FIG. 10 is an isometric view of a distal portion of the tongue member of FIG. 7.

FIG. 11 is a top view of the distal portion of the tongue member of FIG. 7.

FIG. 12 is an isometric view of a tube of the tamper-resistant securing device of FIG. 1.

FIG. 13 is a cross-sectional isometric view of the tube taken along line 13-13 of FIG. 12.

FIG. 14 is an isometric partial view of a proximal end of the tube of FIG. 12.

FIG. 15 is an isometric partial view of a distal end of the tube of FIG. 12.

FIG. 16 is an isometric view of the tamper-resistant securing device of FIG. 1 in an unlocked orientation.

FIG. 17 is an isometric view of the tamper-resistant securing device of FIG. 1 in a locked orientation.

FIG. 18 is an inner isometric partial view of the tamper-resistant securing device of FIG. 1 in the unlocked orientation.

FIG. 19 is a cross-sectional isometric partial view of the tamper-resistant securing device of FIG. 1 in the unlocked orientation taken along line 19-19 of FIG. 16.

FIG. 20 is a cross-sectional isometric view of the tamper-resistant securing device of FIG. 1 in the unlocked orientation taken along line 20-20 of FIG. 16 including a portion of an exemplary bag inserted within the tube.

FIG. 21 is an inner isometric partial view of the tamper-resistant securing device of FIG. 1 in the locked orientation.

FIG. 22 is a cross-sectional top partial view of the tamper-resistant securing device of FIG. 1 in the locked orientation taken along line 22-22 of FIG. 17.

FIG. 23 is a cross-sectional isometric view of the tamper-resistant securing device of FIG. 1 in the locked orientation taken along line 23-23 of FIG. 17 including a portion of the exemplary bag secured within the tube.

FIG. 24 is an exploded isometric view of a tamper-resistant securing device according to another embodiment of the invention.

FIG. 25 is a rear isometric view of a housing portion of the tamper-resistant securing device of FIG. 24.

FIG. 26 is a cross-sectional front isometric view of the housing portion taken along line 26-26 of FIG. 25.

FIG. 27 is a front isometric view of a tongue member of the tamper-resistant securing device of FIG. 24.

FIG. 28 is a rear isometric view of the tongue member of the tamper-resistant securing device of FIG. 24.

FIG. 29 is an isometric partial view of a proximal end of a tube of the tamper-resistant securing device of FIG. 24.

FIG. 30 is an isometric view of the tamper-resistant securing device of FIG. 24 in an unlocked orientation.

FIG. 31 is an isometric view of the tamper-resistant securing device of FIG. 24 in a locked orientation.

FIG. 32 is a cross-sectional partial isometric view of the tamper-resistant securing device of FIG. 24 in the locked orientation taken along line 32-32 of FIG. 31.

FIG. 33 is a cross-sectional top partial view of the tamper-resistant securing device of FIG. 24 in the locked orientation taken along line 33-33 of FIG. 31.

FIG. 34 is an isometric view of a tamper-resistant securing device according to another embodiment of the invention, the tamper-resistant securing device in a locked orientation.

FIG. 35 is an isometric view of the tamper-resistant securing device of FIG. 34 in an unlocked orientation.

FIG. 36 is a cross-sectional isometric view the tamper-resistant securing device taken along line 36-36 of FIG. 34.

FIG. 37 is an isometric view of a tamper-resistant securing device according to another embodiment of the invention, the tamper-resistant securing device in an unlocked orientation.

FIG. 38 is an isometric view of the tamper-resistant securing device of FIG. 37 in a locked orientation.

FIG. 39 is an exploded isometric view of the tamper-resistant securing device of FIG. 37.

FIG. 40 is an inner isometric view of a first housing portion of the tamper-resistant securing device of FIG. 37.

FIG. 41 is a cross-sectional side view of the tamper-resistant securing device of FIG. 37 taken along line 41-41 of FIG. 38.

FIG. 42 is an isometric view of the tamper-resistant securing device of FIG. 37 in an unsealed configuration.

FIG. 43 is an isometric view of an insert for a tamper-resistant securing device according to an embodiment of the invention.

FIG. 44 is an exploded front isometric view of a tamper-resistant securing device according to another embodiment of the invention.

FIG. 45 is an isometric view of a slide of the tamper-resistant securing device of FIG. 44.

FIG. 46 is an isometric view of the tamper-resistant securing device of FIG. 44 is an unlocked orientation.

FIG. 47 is an isometric view of the tamper-resistant securing device of FIG. 44 in a locked orientation and including an exemplary bag

FIG. 48 is a flowchart illustrating a method of transporting goods using a tamper-resistant securing device according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items. Unless specified or limited otherwise, the terms “mounted,” “connected,” “supported,” and “coupled,” and variations thereof, are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

The following discussion is presented to enable a person skilled in the art to make and use embodiments of the invention. Given the benefit of this disclosure, various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Generally, some embodiments of the invention can include a tamper-resistant securing device that may be used with a container to secure goods therein during transit. For example, in some embodiments, the tamper-resistant securing device comprises a tamper-resistant clip that may be applied to a bag containing a take-out food order that can be picked up from a seller (e.g., a restaurant), transported via a delivery service, and delivered to a customer. Shortly after the food has been placed inside the bag, the tamper-resistant clip can be moved from an unlocked orientation to a locked orientation (and simultaneously a sealed configuration) to secure the bag relative to the tamper-resistant clip. When the tamper-resistant clip is moved from the unlocked orientation to the locked orientation, a unique identifier is revealed and the goods within the bag are generally inaccessible while the clip is in the sealed configuration. The unique identifier may be scanned or otherwise transmitted to inform the customer and/or a delivery service platform that the goods are secured within the bag. The goods can remain secured within the bag until a seal of tamper-resistant clip is broken (i.e., the tamper-resistant clip is in an unsealed configuration), which is likely performed by the intended recipient (e.g., the customer). In some embodiments, once the tamper-resistant clip is moved from a sealed configuration to an unsealed configuration, the seal configuration may not be readily reestablished.

Additionally, some embodiments of the invention can include a tamper-resistant securing device for securely transporting goods between a distributer and a customer. For example, a tamper-resistant fastener can secure medicine or other pharmaceuticals within a container. The tamper-resistant fastener can include a unique identifier, such as a barcode or quick response (QR) code, for example, that may be revealed when the tamper-resistant fastener is moved from an unlocked orientation to a locked orientation. In particular, the tamper-resistant fastener may be placed in the locked orientation and secured relative to the container thereby closing an opening of the container and preventing handling of the contents therein. The unique identifier can then be scanned to notify a system that the contents have been secured. Once the container reaches its destination, the unique identifier can be scanned to document the receipt of the container and a single-use seal of the tamper-resistant fastener can be broken to grant access to the contents within the container. The single-use seal provides confirmation that the contents within the container were not handled between the time the tamper-resistant fastener was locked and secured to the container, and when the seal was broken.

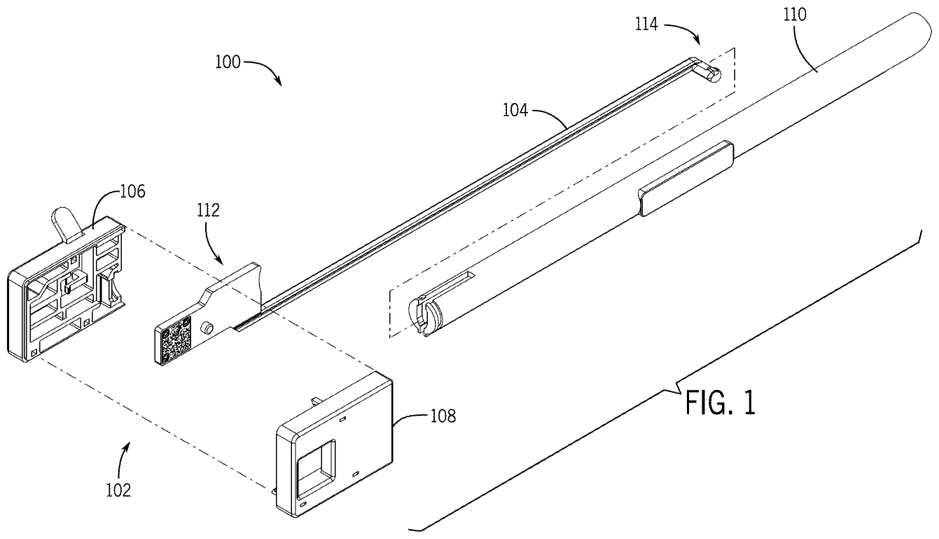

FIGS. 1-23 illustrate a clip 100 according to one example embodiment of the invention. The clip 100 is configured as a tamper-resistant securing device that can engage and secure a container, such as a bag, for example, so that contents within the container are unable to be readily accessed and handled when the clip 100 is in a locked orientation and a sealed configuration. As briefly described above, and according to embodiments of the invention, the tamper-resistant securing device is generally configured to provide a tamper-resistant mechanism for a container so that contents of the container remain inaccessible during transit, and so that a breach of the container is apparent from the status of the tamper-resistant securing device.

With reference to FIG. 1, the example clip 100 includes a housing assembly 102 and a tongue member 104. The housing assembly 102 includes a first housing portion 106, a second housing portion 108, and a tube 110. The tongue member 104 includes a trigger portion 112 and a distal portion 114. Each of the first housing portion 106 and the second housing portion 108 are dimensioned to at least partially receive and house the trigger portion 112 of the tongue member 104. The tube 110 is dimensioned to at least partially receive the distal portion 114 of the tongue member 104 therein.

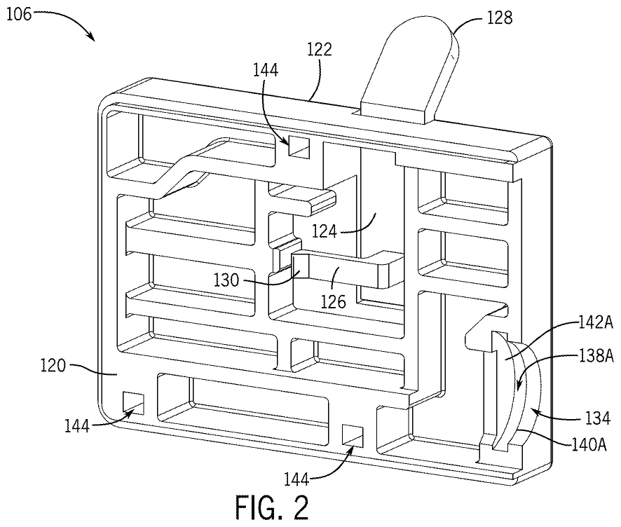

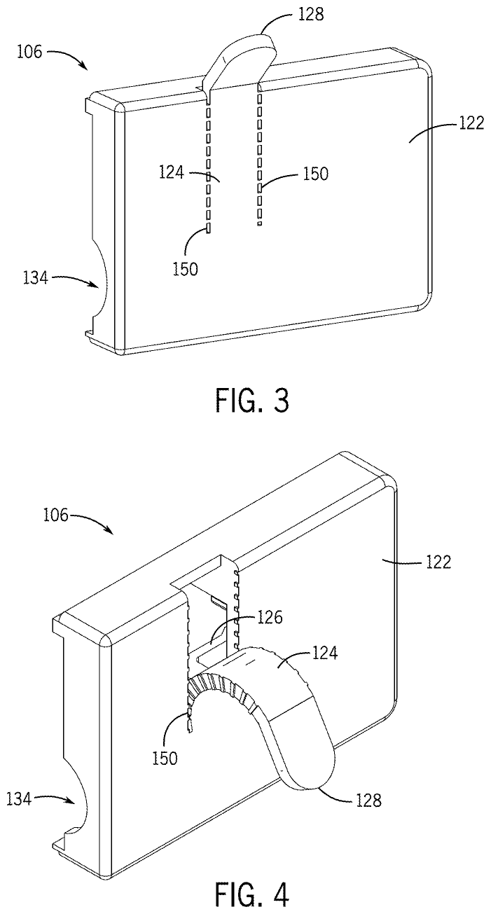

FIG. 2 illustrates an interior side of the first housing portion 106 of the clip 100. The first housing portion 106 defines an interior surface 120 and an exterior surface 122. The first housing portion 106 includes a seal portion 124 disposed between the interior surface 120 and the exterior surface 122. In general, the seal portion 124 is configured to be at least partially disengaged from the first housing portion 106, as will be described below with reference to FIGS. 3 and 4. The seal portion 124 includes a lock arm 126 disposed proximate to the interior surface 120 and a pull tab 128 disposed proximate to the exterior surface 122 when seal portion 124 is in a sealed configuration relative to the first housing portion 106 (e.g., FIGS. 2 and 3). In the illustrated embodiment, the lock arm 126 is integrally formed with the seal portion 124 and includes a tooth 130 that is dimensioned to engage the trigger portion 112 of the tongue member 104.

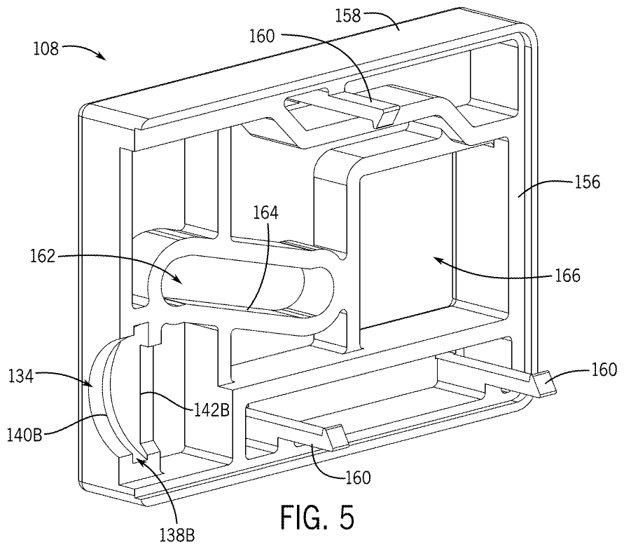

The first housing portion 106 also includes a portion of an opening 134. The portion of the opening 134 formed in the first housing portion 106 includes a slot 138A defined by a front wall 140A and a backstop 142A. In general, the tongue member 104 is configured to extend through the opening 134 and the tube 110 is configured to be secured to each of the first housing portion 106 and the second housing portion 108 at the opening 134. The first housing portion 106 further includes a plurality of securing elements 144. In the illustrated embodiment, the plurality of securing elements 144 are configured as recesses formed in the interior surface 120 of the first housing portion 106 and are dimensioned to receive corresponding elements of the second housing portion 108 (e.g., securing elements 160 shown in FIG. 5) to facilitate securing together the first housing portion 106 and the second housing portion 108 to define the housing assembly 102.

With reference to FIGS. 3 and 4, the seal portion 124 is at least partially bound by lines of material weakness 150 (e.g., perforations, reduced-thickness portions, frangible material segments, etc.) formed in the exterior surface 122 of the first housing portion 106. FIG. 3 illustrates the seal portion 124 in the sealed configuration and FIG. 4 illustrates the seal portion 124 in an unsealed configuration. As illustrated in FIG. 4, the seal portion 124 can be at least partially moved away and separated from the exterior surface 122 of the first housing portion 106, for example, via the pull tab 128. When the pull tab 128 is urged away from the exterior surface 122 and the seal portion 124 is disconnected from the first housing portion 106 along the lines 150, the lock arm 126 moves distally (i.e., away from a central interior position within the first housing portion 106 toward the exterior surface 122). In use, the unsealed configuration of the seal portion 124 corresponds to an unsealed configuration of the clip 100 wherein the tooth 130 disengages from the trigger portion 112 of the tongue member 104.

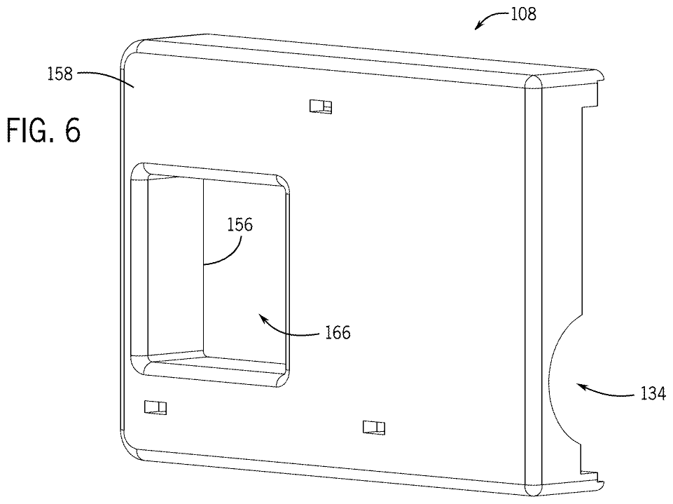

FIGS. 5 and 6 illustrate the second housing portion 108 of the clip 100. The second housing portion 108 defines an interior surface 156 and an exterior surface 158. Similar to the first housing portion 106, the second housing portion 108 includes a portion of the opening 134. The portion of the opening 134 formed in the second housing portion 108 includes a slot 138B defined by a front wall 140B and a backstop 142B, complementary to the portion of the opening 134 formed in the first housing portion 106. The second housing portion 108 further includes a plurality of securing elements 160 configured as latching arms that can engage corresponding structures (not shown) within securing elements 144 of the first housing portion 106 to secure the housing assembly 102.

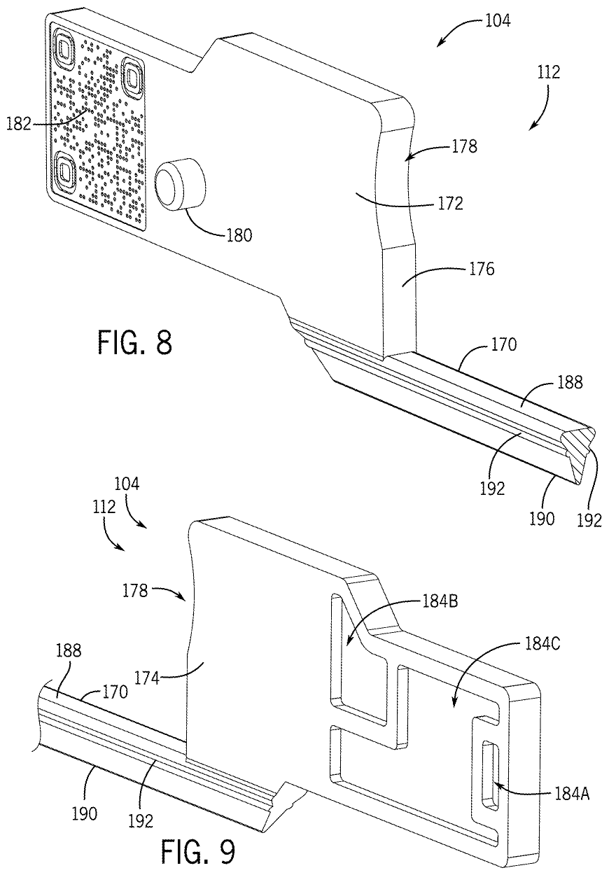

Still referring to FIG. 5, the second housing portion 108 includes a track 162 formed in the interior surface 156. The track 162 is configured as a guide and is dimensioned to receive a guide element (e.g., a protrusion 180) of the trigger portion 112 of the tongue member 104 (see, for example, FIG. 8). The track 162 is bound by a lateral wall 164 and is generally angled with respect to an exterior edge of the second housing portion 108. The track 162 is disposed between the opening 134 and a window 166. As further illustrated in FIG. 6, the window 166 extends between the interior surface 156 and the exterior surface 158. In the illustrated embodiment, the window 166 is configured as a cutout formed in the second housing portion 108. In general, the window 166 provides a degree of visibility from the exterior of the housing assembly 102 to the interior.

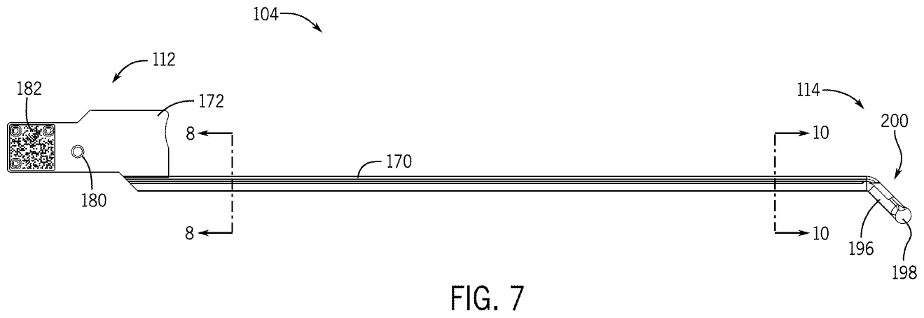

FIGS. 7-11 illustrate the tongue member 104 of the clip 100. As shown in FIG. 7, the tongue member 104 defines a tongue body 170 that extends between the trigger portion 112 and the distal portion 114. With reference to FIGS. 8 and 9, the trigger portion 112 defines a first surface 172 and an opposing second surface 174. A lateral wall 176 extends between the first surface 172 and the second surface 174. The lateral wall 176 includes a curved portion 178. In general, the curved portion 178 can provide a contact point for a user to engage the trigger portion 112 to actuate the tongue member 104 and move the clip 100 from the unlocked orientation to the locked orientation.

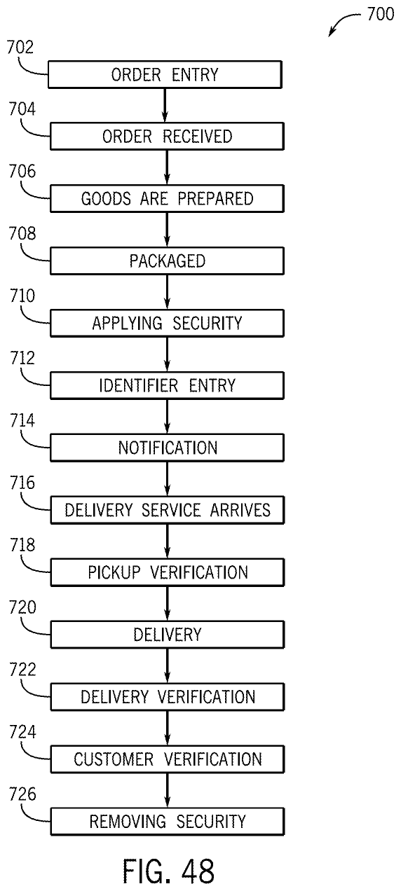

Further illustrated in FIG. 8, the trigger portion 112 includes a guide element configured as a protrusion 180. As briefly discussed above, the protrusion 180 is dimensioned to slide within the track 162 formed in the second housing portion 108. In the illustrated embodiment, the protrusion 180 extends from the first surface 172 of the trigger portion 112. However, in other embodiments, a guide and guide element configuration may be formed such that a track is formed in a surface of the trigger portion 112 (e.g., the first surface 172 or the second surface 174) and a protruding guide element extends from the housing assembly 102 (e.g., the first housing portion 106 or the second housing portion 108). The trigger portion 112 also includes a unique identifier 182 disposed on the first surface 172. In the illustrated embodiment, the unique identifier 182 is configured as a QR code; however, in other embodiments, other configurations are possible. For example, the unique identifier 182 may be a scannable code (e.g., a bar code). In still further embodiments, the clip (e.g., clip 100) may include a unique identifier that need not necessarily be optically scannable, such as passive or active radio frequency identification tags (e.g., RFID tags), near-field communication devices (NFC devices), WI-FI chips, and the like that may establish a unique identifier for a particular clip, and that may be interfaced or communicated with via, for instance, wireless communication protocols (e.g., BLUETOOTH protocol, NFC protocol, IEEE 802.11-based protocols). One skilled in the art will appreciate that the uniqueness of the identifiers need not be absolutely or globally unique, but in some instances only sufficiently unique to distinguish from other identifiers currently in use. In some applications, as can be influenced by application-specific requirements, the unique identifier can be reused after a particular clip has completed a lifecycle (e.g., see the example method discussed below in connection with FIG. 48).

With reference to FIG. 9, the trigger portion 112 also includes a first recess 184A, a second recess 184B, and a third recess 184C formed in the second surface 174. As will be described below with reference to FIGS. 19 and 22, each of the recesses 184A-C are dimensioned to at least partially engage the tooth 130 of the lock arm 126. In general, an engagement of the tooth 130 with the first recess 184A corresponds to the clip 100 in the unlocked orientation, and an engagement of the tooth 130 with the second recess 184B corresponds to the clip 100 in the locked orientation.

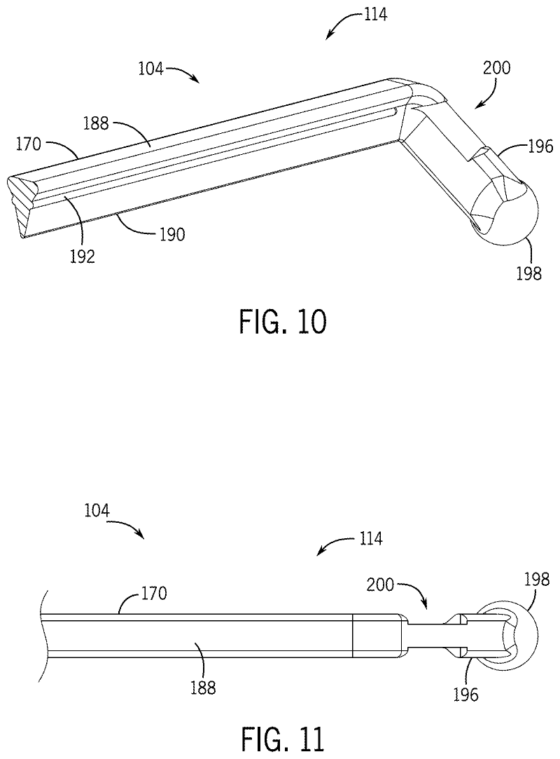

FIGS. 8 and 10 illustrate the cross-sectional profile of the example tongue body 170. The cross-sectional profile of the tongue body 170 is generally triangular and includes a flat surface 188 and a rounded edge 190 opposite the flat surface 188. The tongue member 104 also includes a pair of parallel ridges 192 that extend along opposing sides of the tongue body 170 between the flat surface 188 and the rounded edge 190.

With reference to FIGS. 10 and 11, the distal portion 114 of the tongue member 104 includes an end segment 196 that extends from and is angled relative to the tongue body 170. The end segment 196 includes a rounded end 198 and a narrowed portion 200. The rounded end 198 defines a partial spherical shape that defines a diameter that is greater than the width of the end segment 196. The narrowed portion 200 defines a width that is less than the width of the end segment 196 proximate to the rounded end 198.

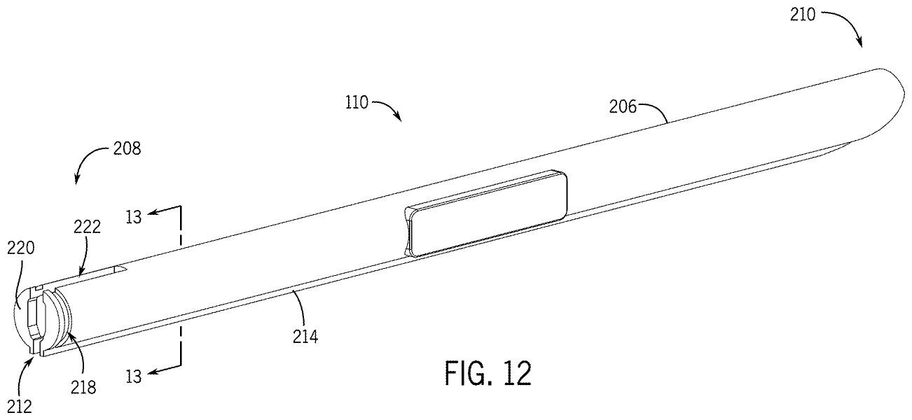

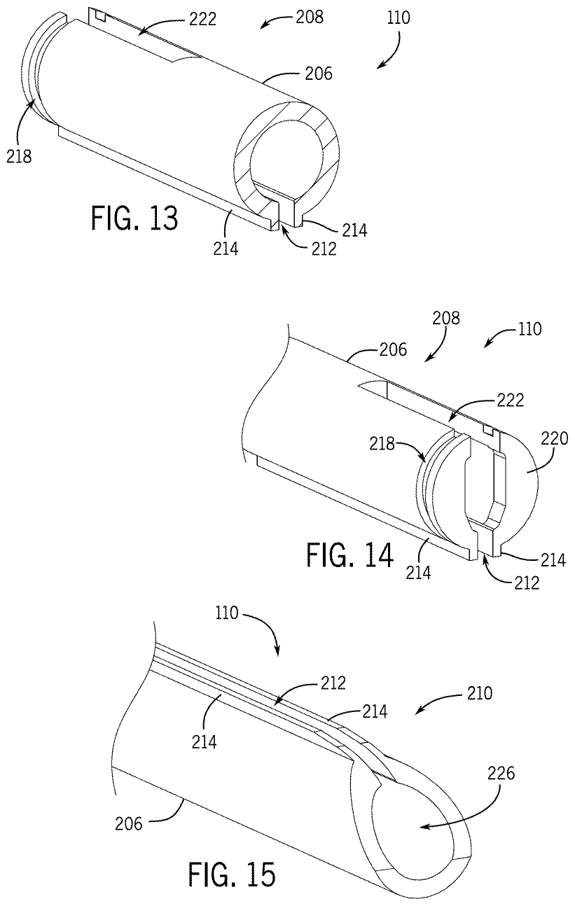

FIGS. 12-15 illustrate the example tube 110 of the clip 100. As shown in FIG. 12, the tube 110 defines a tube body 206 that extends between a proximal portion 208 and a distal portion 210. The tube body 206 is a generally cylindrical body having a slit 212 formed therein that extends the length of the tube body 206. As illustrated in FIGS. 13-15, the tube body 206 includes lips 214 that extend generally radially from the tube body 206 on either side of the slit 212. In some embodiments, as illustrated in FIG. 12, the tube body 206 can include a flat or planar portion to which a label, such as a brand identifier, may be printed or otherwise affixed.

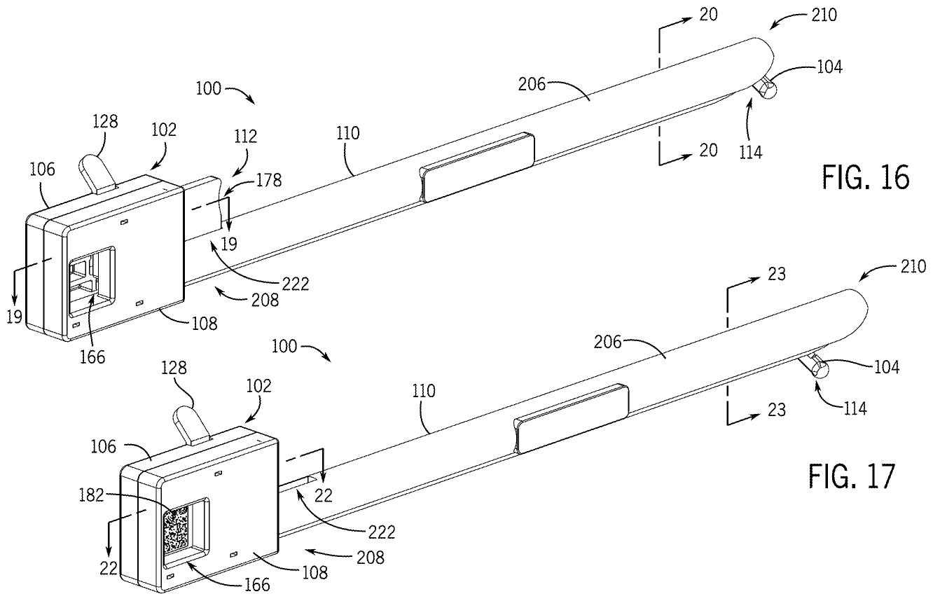

FIGS. 13 and 14 illustrate the proximal portion 208 of the tube body 206. The proximal portion 208 includes an annular groove 218 and a proximal wall 220. When the housing 102 is assembled, each of the front walls 140A, 140B of the respective first and second housing portions 106, 108 are seated within the annular groove 218, and the proximal wall 220 is seated within the slots 138A, 138B of the respective first and second housing portions 106, 108 to secure the tube 110 to the housing assembly 102 at the opening 134. The proximal portion 208 of the tube body 206 also includes a slot 222 through which the trigger portion 112 of the tongue member 104 can extend through (see, for example, FIG. 16). FIG. 15 illustrates the distal portion 210 of the tube body 206. The distal portion 210 includes an opening 226. In the illustrated embodiment, the opening 226 is skewed relative to an axis defined by the tube body 206.

FIG. 16 illustrates the clip 100 in the unlocked orientation. In the unlocked orientation the tongue member 104 extends through the tube 110, and the distal portion 114 of the tongue member 104 extends beyond the opening 226 at the distal portion 210 of the tube body 206. Additionally, the trigger portion 112 extends into the slot 222 of the proximal portion 208 of the tube body 206. To move the clip 100 from the unlocked orientation to the locked orientation, a user can engage the trigger portion 112 at the curved portion 178 to urge the tongue member 104 toward the first and second housing portions 106, 108. For example, FIG. 17 illustrates the clip 100 in the locked orientation. In the locked orientation, the distal portion 114 of the tongue member 104 is moved away from the opening 226 along the slit 212. Additionally, in the locked orientation, the unique identifier 182 is moved toward the window 166 so that the unique identifier 182 is visible from outside the housing assembly 102.

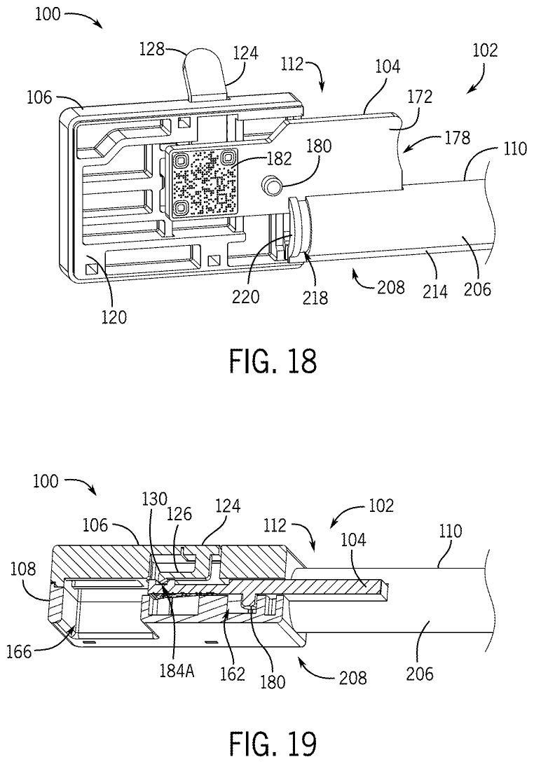

FIGS. 18 and 19 illustrate an example of the internal configuration within the housing assembly 102 of the clip 100 in the unlocked orientation. In particular, FIG. 18 shows the internal position of the unique identifier 182 within the housing assembly 102 such that the unique identifier 182 is not visible (e.g., may not be scannable through the window 166) from outside the housing assembly 102 in the unlocked orientation. FIG. 19 illustrates the engagement of the tooth 130 of the first housing portion 106 with the first recess 184A of the trigger portion 112 and the engagement of the protrusion 180 with a first end of the track 162 of the second housing portion 108.

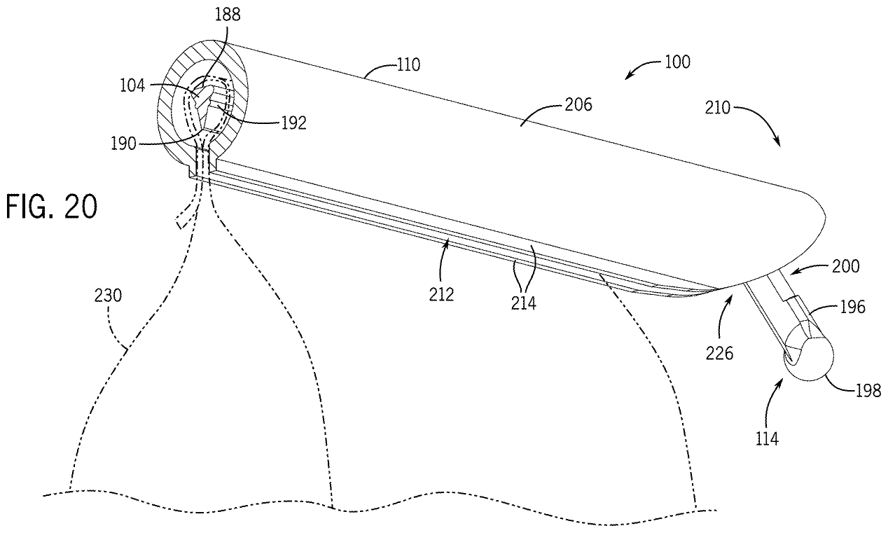

With reference to FIG. 20, in use, when the clip 100 is in the unlocked orientation, a container, such as a bag 230 may form a partial loop that can be slid over the distal portion 114 of the tongue member 104 near the opening 226. The bag 230 can then extend through the slit 212 so that the bag 230 is at least partially wrapped around the tongue member 104 within the tube 110. It should be appreciated that the bag 230 is by way of example and other containers with closeable tops are possible.

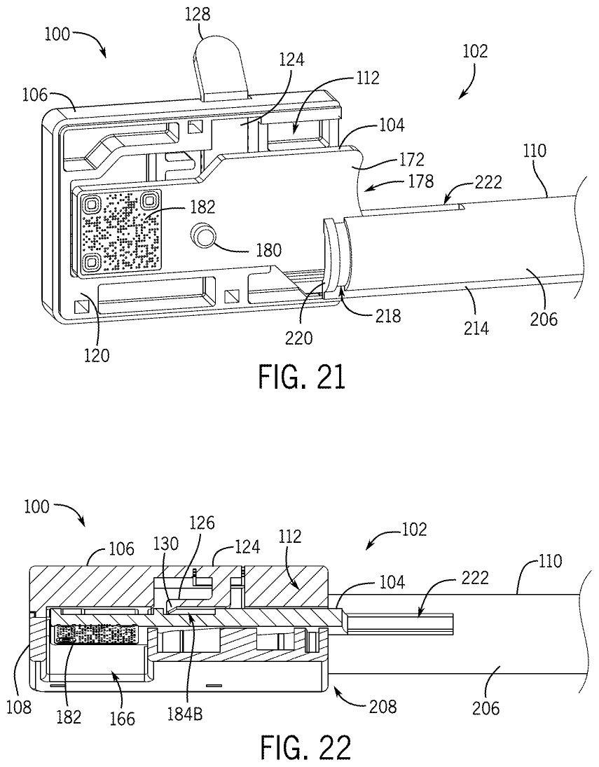

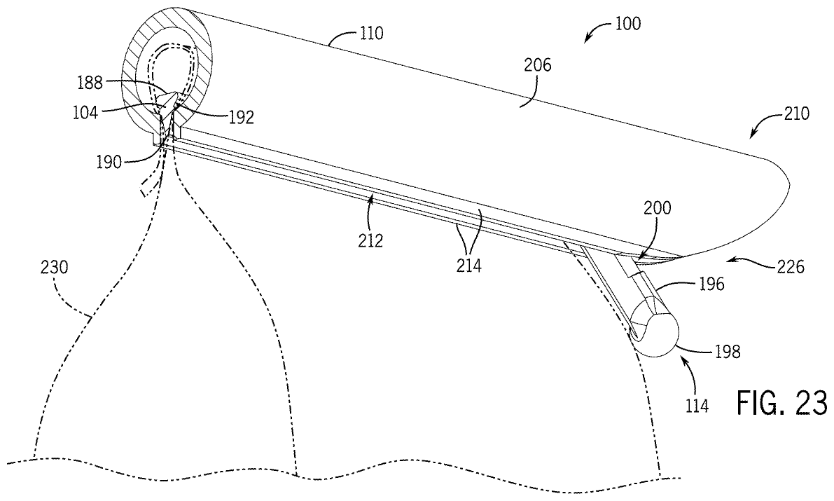

FIGS. 21 and 22 illustrate an example of the internal configuration within the housing assembly 102 of the clip 100 in the locked orientation. In particular, FIG. 21 shows the internal position of the unique identifier 182 within the housing assembly 102 such that the unique identifier 182 is moved to a position visible (e.g., may be scannable through the window 166) from outside the housing assembly 102. FIG. 22 illustrates the engagement of the tooth 130 of the first housing portion 106 with the second recess 184B of the trigger portion 112. The angled portion of the tooth 130 prevents the trigger portion 112 from moving in a reverse direction (i.e., back toward the unlocked orientation when the tooth 130 is engaged with the first recess 184A) while the clip 100 is in the sealed configuration. Additionally, though not shown in FIG. 22, as the trigger portion 112 is moved toward the locked orientation, the protrusion 180 cams downward along the track 162, which moves the rounded edge 190 of the tongue body 170 toward the slit 212. When the trigger portion 112 is secured in the locked orientation, the protrusion 180 is disposed proximate to a second end of the track 162 of the second housing portion 108 resulting in the tongue member 104 wedging the bag 230 between the ridges 192 and the slit 212 (see, for example FIG. 23).

With reference to FIG. 23, when the clip 100 is in the locked orientation, the bag 230 is secured within the tube 110 (e.g., the bag 230 is inhibited from being removed from the opening 226 or urged away from the slit 212). In particular, the ridges 192 of the tongue member 104 are urged downward toward the slit 212 and the triangular cross section of the tongue member 104 is generally wedged in the slit 212 so that the bag 230 is secured between the tongue member 104 and the tube 110 proximate to the slit 212 via the ridges 192 that extend along the tongue body 170. In general, the tongue member 104 is configured as a lock member that can secure a container relative to the housing assembly 102.

In use, the bag 230 can remain secured via the clip 100 until the pull tab 128 is at least partially detached along the lines of material weakness 150 from the first housing portion 106 to disengage the tooth 130 from the second recess 184B. Once the clip 100 is in the unsealed configuration, the tongue member 104 is free to slide toward the unlocked orientation. The bag 230 can be removed from the clip 100 at the distal portion 114 of the tongue member 104 extending through the opening 226 at the distal portion 210 of the tube body 206. As briefly described above, once the clip 100 is in the unsealed configuration, the seal formed by the pull tab 128 and the first housing portion 106 cannot be readily reestablished.

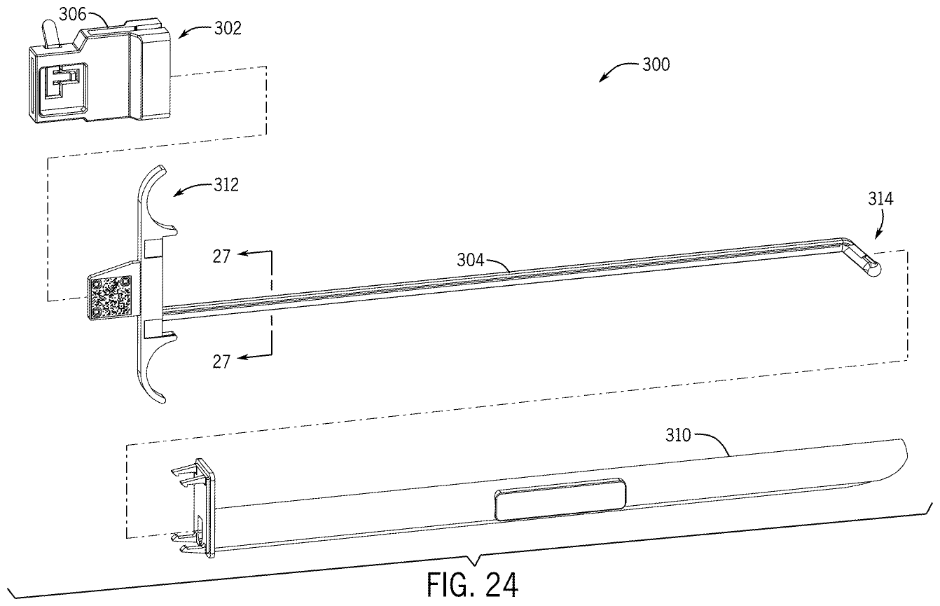

FIGS. 24-33 illustrate a clip 300 according to another example embodiment of the invention. Similar to the clip 100, the clip 300 is configured as a tamper-resistant securing device that can engage and secure a container, such as bag 230, for example, so that the contents within the bag 230 are unable to be readily handled when the clip 300 is in a locked orientation and a sealed configuration. The clip 300 includes a housing assembly 302 and a tongue member 304. The housing assembly 302 includes a first housing portion 306 and a tube 310. The tongue member 304 includes an actuation portion 312 and a distal portion 314. The first housing portion 306 is dimensioned to at least partially receive and house the actuation portion 312 of the tongue member 304. The tube 310 is dimensioned to at least partially receive the distal portion 314 of the tongue member 304 therein.

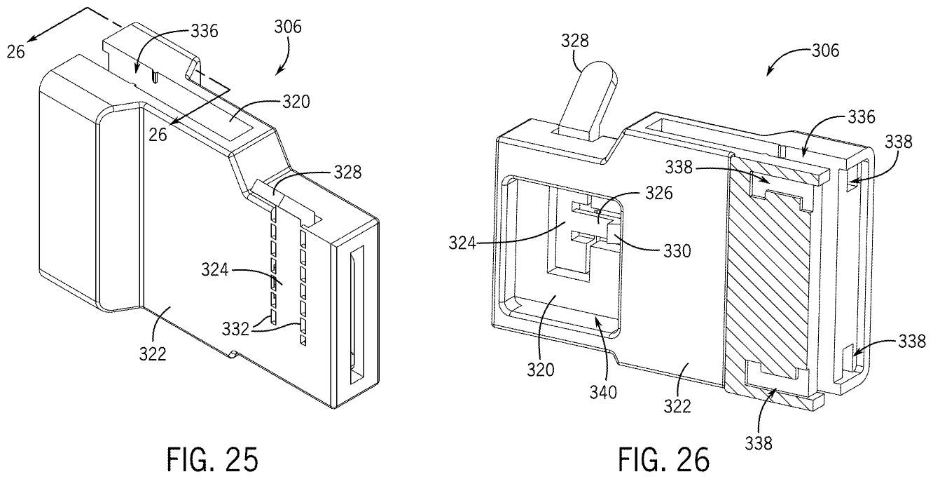

FIGS. 25 and 26 illustrate the first housing portion 306 of the clip 300. The first housing portion 306 defines an interior surface 320 and an exterior surface 322. Similar to the first housing portion 106, the first housing portion 306 includes a seal portion 324 disposed between the interior surface 320 and the exterior surface 322. Like the seal portion 124, the seal portion 324 is configured to be disengaged from the first housing portion 306 along lines of material weakness 332 to unseal the clip 300. The seal portion 324 includes a lock arm 326 disposed proximate to the interior surface 320 and a pull tab 328 disposed proximate to the exterior surface 322 when the seal portion 324 is in a sealed configuration relative to the first housing portion 306 (e.g., FIGS. 25 and 26). In the illustrated embodiment, the lock arm 326 is integrally formed with the seal portion 324 and includes a tooth 330 that is dimensioned to engage the tongue member 304 at the actuation portion 312.

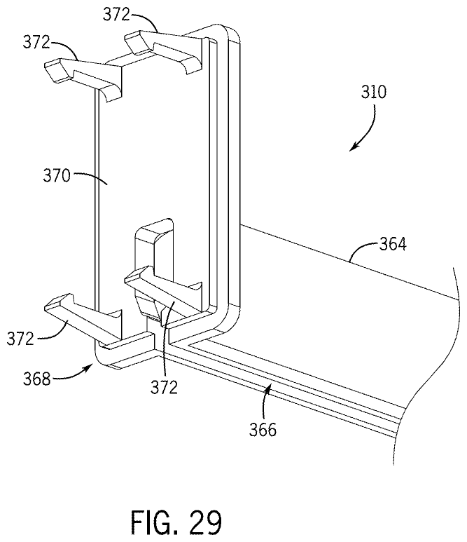

The first housing portion 306 also includes an opening 336. The opening 336 is dimensioned to receive the actuation portion 312 of the tongue member 304. As shown in FIG. 26, proximate to the opening 336, the first housing portion 306 includes securement recesses 338. The securement recesses 338 are dimensioned to receive corresponding securing elements of the tube 310 (e.g., arms 372), as will be described with reference to FIG. 29. Like the housing assembly 302, the first housing portion 306 further includes a window 340 formed between the interior surface 320 and the exterior surface 322.

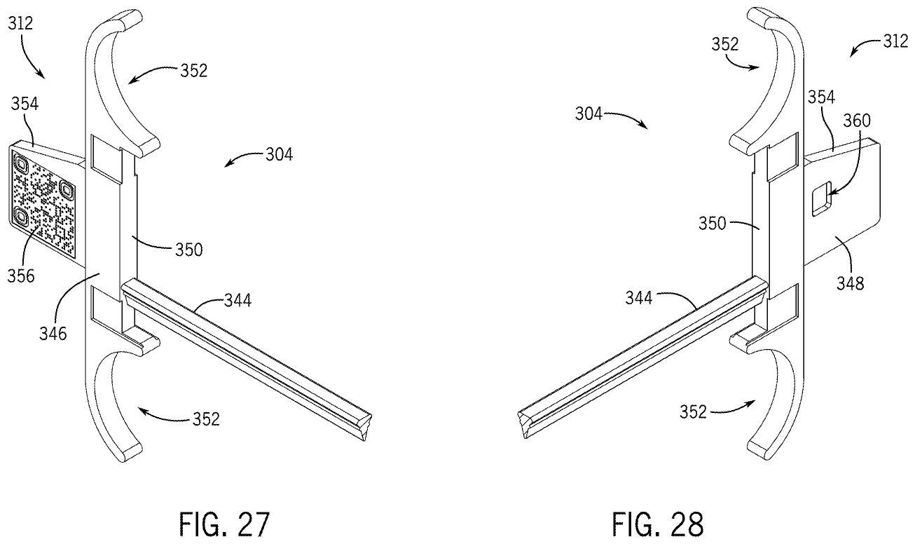

FIGS. 27 and 28 illustrate a portion of the tongue member 304 of the clip 300. The tongue member 304 defines a tongue body 344 that extends between the actuation portion 312 and the distal portion 314 (not shown in FIGS. 27 and 28). The tongue body 344 and the distal portion 314 of the tongue member 304 are similar to that of the tongue member 104, and therefore will not be described in further detail. The actuation portion 312 defines a first surface 346 and an opposing second surface 348. A lateral surface 350 extends between the first surface 346 and the second surface 348. The lateral surface 350 includes a pair of curved portions 352. In general, the pair of curved portions 352 can provide a contact point for a user to engage the actuation portion 312 to actuate the tongue member 304 and move the clip 300 from the unlocked orientation to the locked orientation. Additionally, a cam surface 354 extends between the first surface 346 and the second surface 348.

Further illustrated in FIG. 27, like the tongue member 104, the tongue member includes a similar unique identifier 356 disposed on the first surface 346. As shown in FIG. 28, the second surface 348 of the actuation portion 312 includes a recess 360 formed therein. Like the recesses 184A-C of the tongue member 104, the recess 360 is dimensioned to at least partially engage the tooth 330 of the lock arm 326. In general, the engagement of the tooth 330 with the recess 360 corresponds to the clip 300 in the locked orientation.

FIG. 29 illustrates a portion of the tube 310 of the housing assembly 302. Like the tube 110, the tube 310 defines a tube body 364 having a slit 366 that extends between a proximal portion 368 and a distal portion (not shown in FIG. 29). The tube body 364 and the distal portion of the tube 310 are similar to that of the tube 110, and therefore will not be described in further detail. The proximal portion 368 of the tube 310 includes an engagement face 370 configured to engage the first housing portion 306. The engagement face 370 includes a plurality of arms 372 configured as securing elements and dimensioned to be received by the securement recesses 338 of the first housing portion 306 to enable securing the housing assembly 302. For example, the arms 372 may provide a one-way snap fit such that the arms 372 can be inserted into the securement recesses 338 in a first direction, but may be prohibited from being removed from the securement recesses 338 in an opposing second direction.

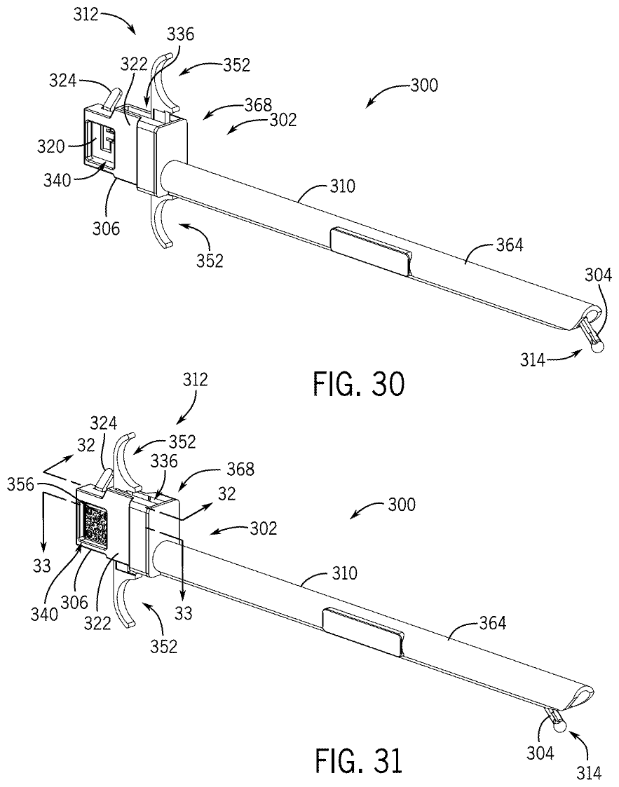

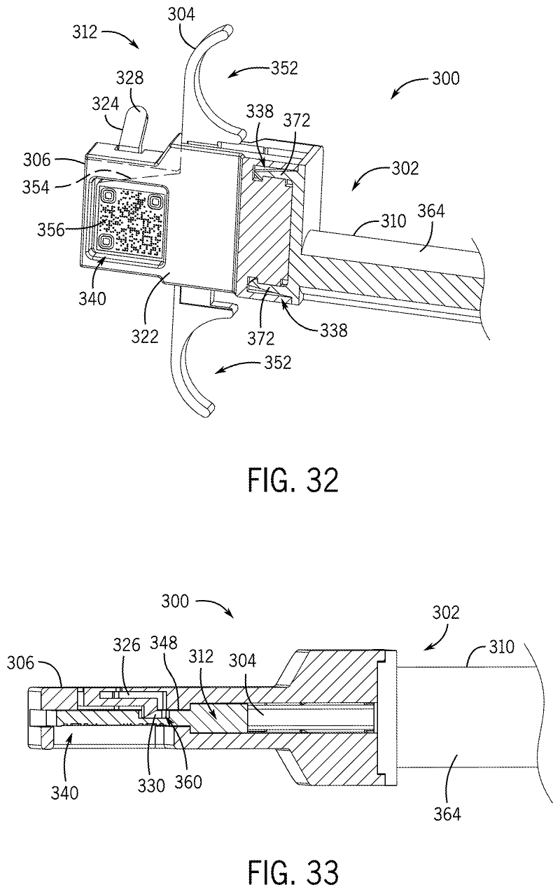

FIG. 30 illustrates the clip 300 in the unlocked orientation. Similar to the clip 100, in the unlocked orientation, the tongue member 304 extends through the tube 310. Additionally, in the unlocked orientation, the actuation portion 312 is positioned at a distal portion of the opening 336. To move the clip 300 from the unlocked orientation to the locked orientation, a user can engage the actuation portion 312 at the curved portions 352 to urge the tongue member 304 toward a proximal end of the first housing portion 306 (e.g., toward the window 340). For example, FIG. 31 illustrates the clip 300 in the locked orientation. Like the clip 100, when the clip 300 is in the locked orientation, the distal portion of the tongue member 304 is moved away from an opening at the distal end of the tube body 364. Additionally, in the locked orientation, the unique identifier 356 is visible from outside the housing assembly 302. As the actuation portion 312 is moved toward the locked orientation, the cam surface 354 is moved along a guide, such as an internal corner formed within the first housing portion 306 (see, for example, FIG. 32). The cam surface 354 is angled downward so that when the tongue member 304 is moved toward the locked orientation, the tongue body 344 is moved downward within the tube 310, similar to the movement of the tongue member 104 when moved from the unlocked orientation to the locked orientation.

FIGS. 32 and 33 illustrate examples of internal configurations within the housing assembly 302 of the clip 300 when in the locked orientation. In particular, FIG. 32 illustrates the engagement of the arms 372 within the securement recesses 338 of the first housing portion 306.

Additionally, FIG. 33 illustrates the engagement of the tooth 330 of the lock arm 326 with the recesses 360 in the second surface 348 of the actuation portion 312.

In use, a container may be at least partially wrapped around the tongue member 304 when the clip 300 is in the unlocked orientation and then secured within the tube 310 when the clip 300 is in the locked orientation, which establishes a wedging or clamping retention arrangement as the tongue body 344 is urged toward the slit 366 in the tube body 364. The container can remain secured via the clip 300 until the pull tab 328 is at least partially detached along the lines of material weakness 332 from the first housing portion 306 to disengage the tooth 330 from the recess 360. Once the clip 300 is in the unsealed configuration, the tongue member 304 is free to slide toward the unlocked orientation and the container can be removed from the clip 300.

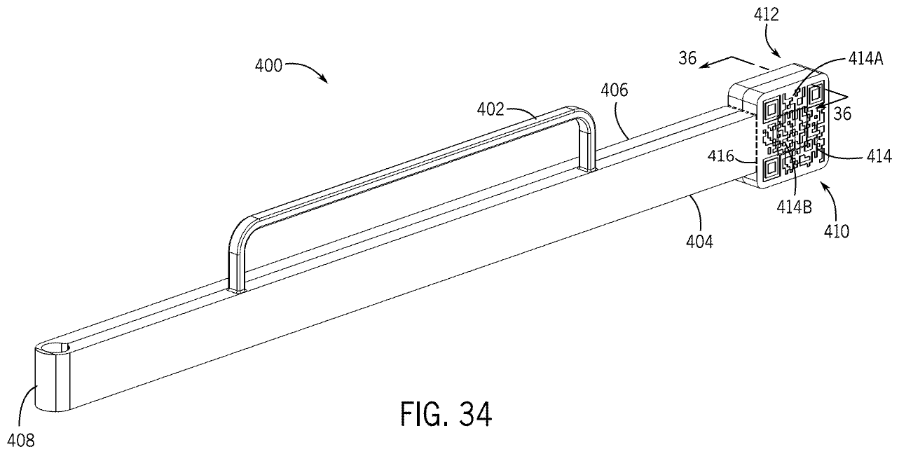

FIGS. 34-36 illustrate a clip 400 according to another example embodiment of the invention. The clip 400 is generally configured as a tamper-resistant securing device that can engage and secure a container, such as a bag, for example, so that the contents within the container are unable to be handled or tampered with when the clip 400 is in a locked orientation and a sealed configuration. As shown in FIG. 34, the clip 400 includes a handle 402, a first clip portion 404, and a second clip portion 406. The first clip portion 404 and the second clip portion 406 are pivotably coupled at a hinge 408 (e.g., a living hinge, such as when the first clip portion 404 and the second clip portion 406 are produced from plastics). Each of the first clip portion 404 and the second clip portion 406 include a corresponding first proximal end 410 and second proximal end 412, respectively. In the illustrated example, the first proximal end 410 and the second proximal end 412 interface to form a unique identifier 414, similar to the unique identifier 182, when the first proximal end 410 and the second proximal end 412 are engaged in the locked orientation and the sealed configuration.

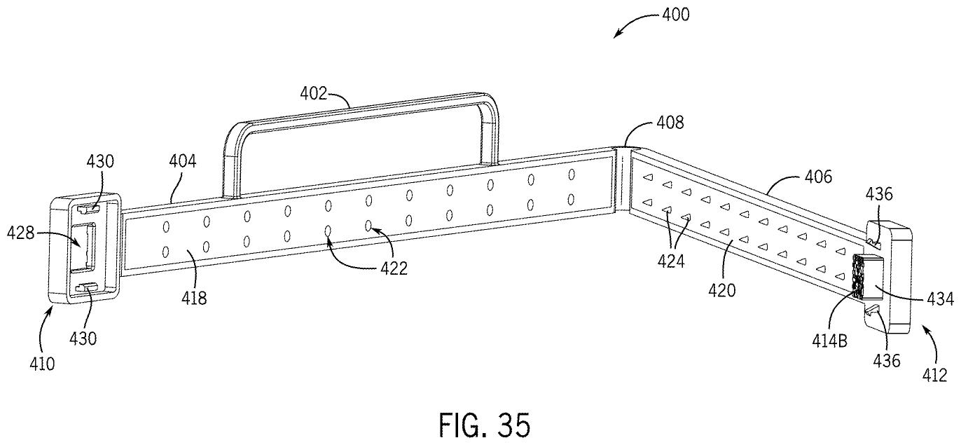

FIG. 35 illustrates the clip 400 in an unlocked orientation. Each of the first clip portion 404 and the second clip portion 406 include a respective first interior surface 418 and second interior surface 420. The first interior surface 418 includes a plurality of recesses 422 and the second interior surface 420 includes a plurality of corresponding protrusions 424. The plurality of recesses 422 are each dimensioned to receive a corresponding protrusion 424 and, in some forms, a portion of a container to be secured (e.g., the thickness of two sheets of a bag). The combination of the recesses 422 and the protrusions 424 generally provide a lock member configuration to secure a container relative to the housing assembly of the clip 400.

As further shown in FIG. 35, the first proximal end 410 includes a cutout 428 and a first pair of arms 430 on opposing sides of the cutout 428. On an exterior surface of the first proximal end 410 opposite the first arms 430, a portion 414A of the unique identifier 414 surrounds the cutout (see, for example, FIG. 34). Another portion of the unique identifier 414B is formed on an end of a boss 434 extending from the second proximal end 412. The second proximal end 412 also includes a second pair of arms 436 that are configured to provide a snap fit with the first pair of arms 430.

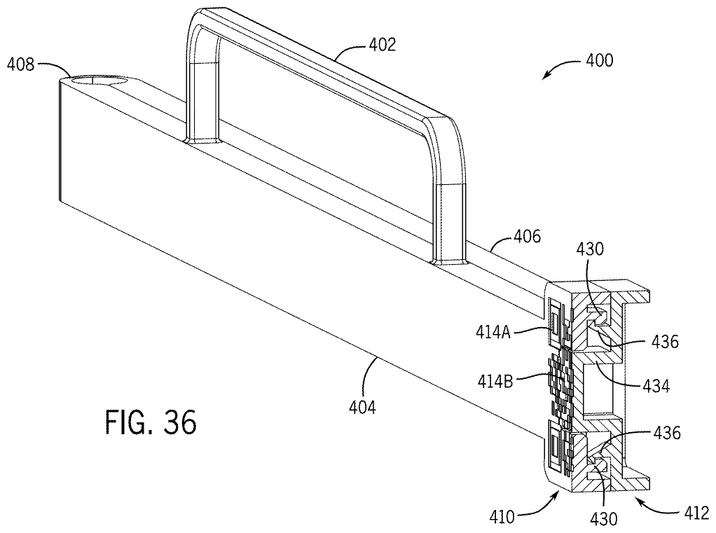

As illustrated in FIG. 36, when the clip 400 is in the locked orientation, the first and second portions 414A, 414B form the complete unique identifier 414. Additionally, the first pair of arms 430 are locked and engaged with the second pair of arms 436. Once the arms 430, 436 become disengaged (e.g., such as by breaking or deforming one or more of the arms 430, 436), the completed unique identifier is interrupted and unusable (e.g., unable to be scanned). Therefore, in some embodiments, once the clip 400 is moved from the locked orientation to the unlocked orientation, the unique identifier 414 may not be readily reassembled and the clip 400 may be discarded. In some forms, at least one or more of the lock arms 430, 436 must be broken (e.g., dislodge at a base) to permit opening of the clip 400 from the locked orientation, thus inhibiting resealing of the clip 400 back to the locked orientation.

In use, a first user (e.g., a seller) may put items such as food or medicine (or other goods that are intended not to be tampered with) into a container (e.g., a bag). The bag may be inserted between the first clip portion 404 and the second clip portion 406 when the clip 400 is in an unused and unlocked position. The clip 400 may then be secured to the bag with the plurality of recesses 422 and the plurality of corresponding protrusions 424 that engage with and restrain the bag. The engagement of the lock arms 430, 436 secures the clip 400 in the locked orientation. The first user can then scan the unique identifier 414 to alert a system (or an end user) that the items within the bag are ready for transit. Once transit is complete, an end user (e.g., a customer or consumer) can confirm that the contents of the bag have not been tampered with if the completed unique identifier 414 is still intact. The end user can then separate the first proximal end 410 from the second proximal end 412 to disrupt the integrity of the clip 400 and/or the unique identifier 414 and open the clip 400 to remove the bag.

In some forms, the clip 400 can include a line of material weakness 416 (shown, for instance, in FIG. 34) that separates the proximal end 410, 412 from the respective clip portion 404, 406. As one example, opening a sealed clip 400 can result in the proximal end portions 410, 412 being twisted, bent, or otherwise broken off from the clip portions 404, 406. As a result, a locking mechanism (e.g., the arms 430, 436) is no longer part of the clip 400 and the clip portions 404, 406 can be opened relative to one another to remove the goods previously sealed in the clip 400.

In other forms, opening the clip 400 from the locked orientation results in destruction or disfiguring of at least one of the first and second portions 414A, 414B of the unique identifier 414, such that an attempt to realign and reclose the clip 400 is inhibited. As one example, opening a sealed clip 400 results in the base of the lock arms 430, which are integrally formed with the first portion 414A of the unique identifier, pulling away from the first proximal end 410 (e.g., such as by including a material weakness proximate the base of the lock arms 430) causing a discontinuity in the unique identifier 414 that is not readily remedied. Additionally, in some examples, opening the clip 400 from the locked orientation can result in one or more of the arms 430, 436 disconnecting from the respective proximal end 410, 412 so that a locked orientation may not be readily reestablished.

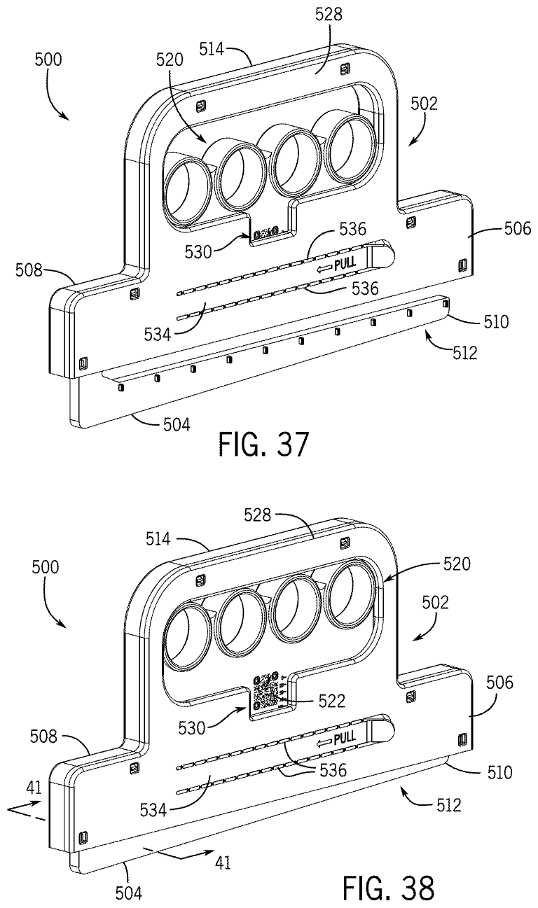

FIGS. 37-42 illustrate a clip 500 according to another example embodiment of the invention. The clip 500 is configured as a tamper-resistant securing device that can engage and secure a container, such as a bag, for example, so that the contents within the bag are unable to be readily accessed or handled when the clip 500 is in a locked orientation and a sealed configuration. The clip 500 includes a housing assembly 502 and a lock member 504. The housing assembly 502 includes a first housing portion 506 and a second housing portion 508. The lock member 504 can be secured between the first housing portion 506 and the second housing portion 508 and is configured to be moved between an unlocked orientation (see FIG. 37) and the locked orientation (see FIG. 38).

In the unlocked orientation, a tongue member 510 is exposed outside the housing assembly 502. The tongue member 510 includes a distal end 512 that is configured as an open end where a portion of a container, such as a bag, can be inserted between the tongue member 510 and the housing assembly 502. In use, once the bag is inserted between the tongue member 510 and the housing assembly 502, the clip 500 can be moved into the locked orientation to secure the bag for transit. In the illustrated embodiment, the lock member 504 can be moved generally upward relative to the housing assembly 502 to lock the clip 500.

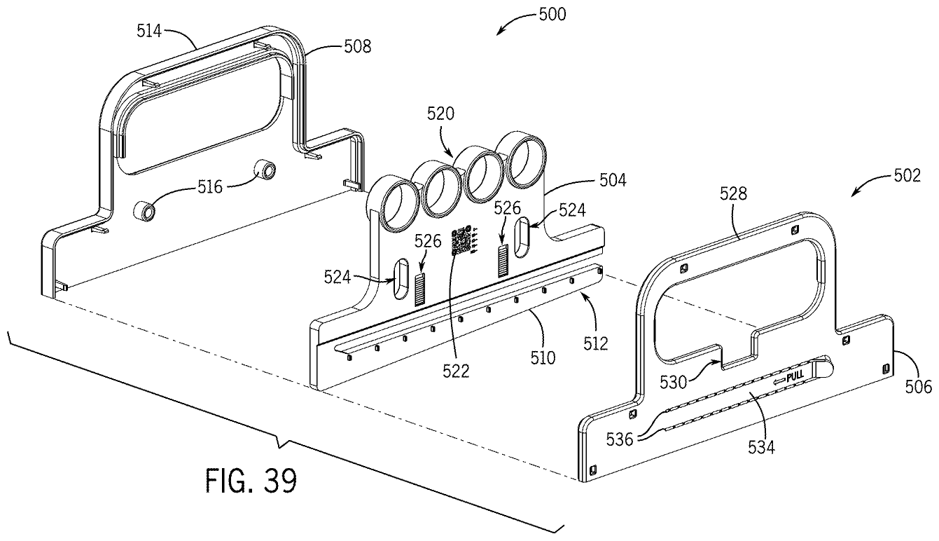

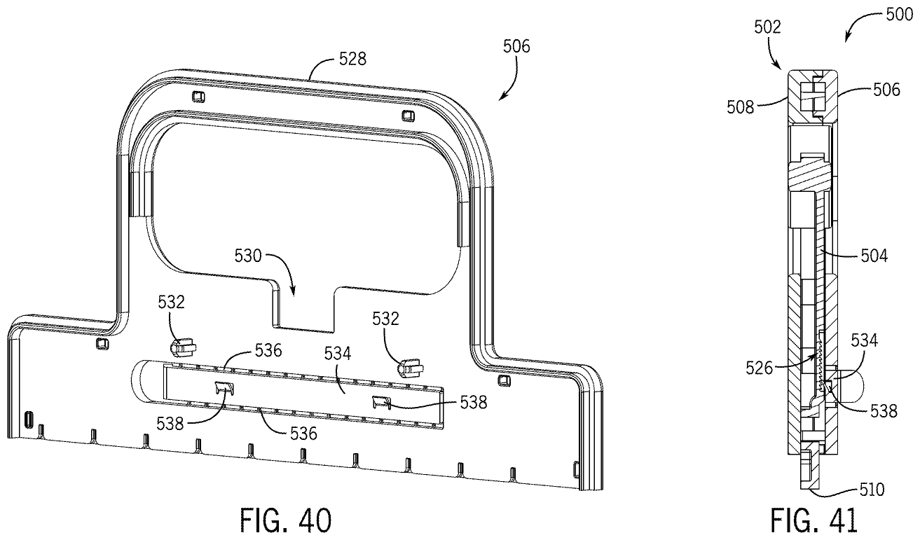

With reference to FIG. 39, the second housing portion 508 includes a handle 514 and defines an interior surface. The interior surface includes securing elements 516 configured as hollow protrusions that are dimensioned to receive corresponding securing elements 532 of the first housing portion 506 (see, for example, FIG. 40). The lock member 504 includes an actuation portion 520, a unique identifier 522, a pair of through holes 524, and recessed portions 526.

In the illustrated embodiment, the actuation portion 520 is configured as four through holes. In use, one or more through holes may be grasped by one or more fingers of a user to actuate the lock member 504. Like the unique identifier 182, the unique identifier 522 may be configured, for instance, as a QR code. The pair of through holes 524 allow the securing elements 532 of the first housing portion 506 to extend through the lock member 504 and engage the securing elements 516. In the illustrated embodiment, the lock member 504 includes a pair of recessed portions 526 each having a plurality of teeth. However, in other configurations, more or fewer recessed portions are possible.

As illustrated in FIG. 40, the first housing portion 506 includes a handle 528 that corresponds to the handle 514 of the second housing portion 508. The handle 528 includes a window 530 configured as a cutout. In general, the window 530 provides a degree of visibility from the exterior of the housing assembly 502 to view the unique identifier 522 when the clip 500 is in the locked orientation. An interior surface of the first housing portion 506 includes the securing elements 532. The securing elements 532 are configured as protrusions that can provide, for example, a snap-fit or an interference-fit with the securing elements 516 of the second housing portion 508.

The first housing portion 506 also includes a seal portion 534 disposed between the interior surface and an exterior surface of the first housing portion 506. Like the seal portion 124, the seal portion 534 is configured to be disengaged from the first housing portion 506 along lines of material weakness 536 to unseal the clip 500. The seal portion 534 includes a pair of teeth 538 that are dimensioned to engage the recessed portions 526 of the lock member 504.

FIG. 41 illustrates the clip 500 in a locked orientation. In the locked orientation, each tooth 538 is engaged with the corresponding plurality of teeth of the recessed portion 526. In particular, in the locked orientation, the tooth 538 is engaged with a bottom section of the recessed portion 526. Correspondingly, when the clip 500 is in the unlocked orientation, the tooth 538 is engaged with a top section of the recessed portion 526. The angle of the plurality of teeth within the recessed portion 526 in combination with the angle of the tooth 538 only allow the lock member 504 to slide in a single direction relative to the housing assembly 502. In particular, the engagement of the tooth 538 with the recessed portion 526 prevents the clip 500 from being moved from the locked orientation to the unlocked orientation via the lock member 504 moving downward relative to the housing assembly 502 (i.e., in the direction opposite to move the clip 500 into the locked orientation).

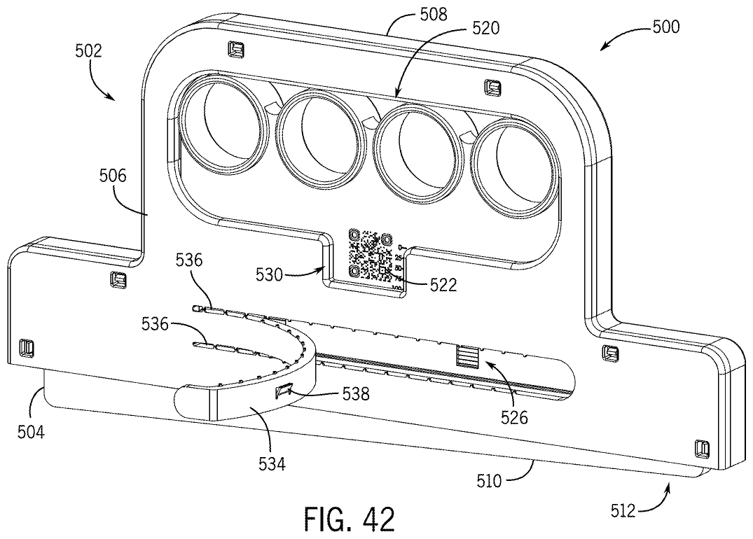

FIG. 42 illustrates the clip 500 in an unsealed configuration. In use, to release the clip 500 from the locked orientation, the seal portion 534 can be at least partially detached along the lines of material weakness 536 from the first housing portion 506 to disengage each tooth 538 from the corresponding recessed portion 526. By detaching the seal portion 534 from the first housing portion 506, the lock member 504 is free to slide from within the housing assembly 502 so that the tongue member 510 extends beyond each of the first housing portion 506 and the second housing portion 508 and the bag can be removed from the clip 500 at the distal end 512 of the tongue member 510.

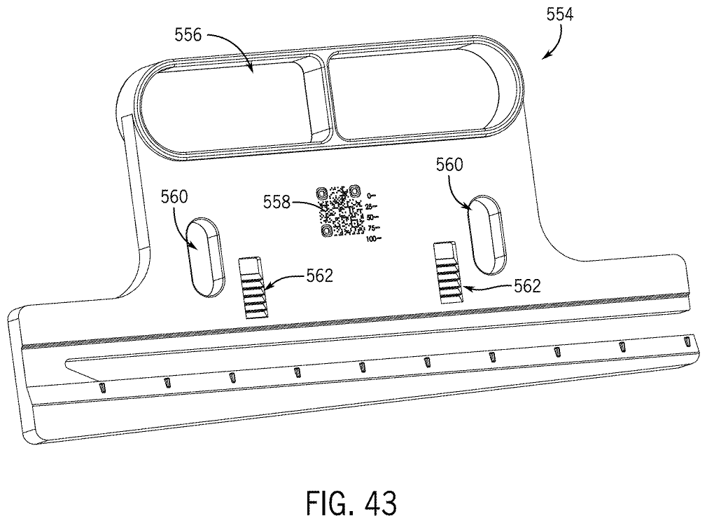

FIG. 43 illustrates a lock member 554 according to another example embodiment of the invention. The lock member 554, like the lock member 504, includes an actuation portion 556, a unique identifier 558, a pair of through holes 560, and recessed portions 562. In the illustrated example, the actuation portion 556 is configured as a pair of cutouts. In use, one or more of the pair of cutouts may be grasped by one or more fingers of a user to actuate the lock member 554. The remaining components of the lock member 554 are substantially similar to those of the lock member 504 and, therefore, will not be described in further detail.

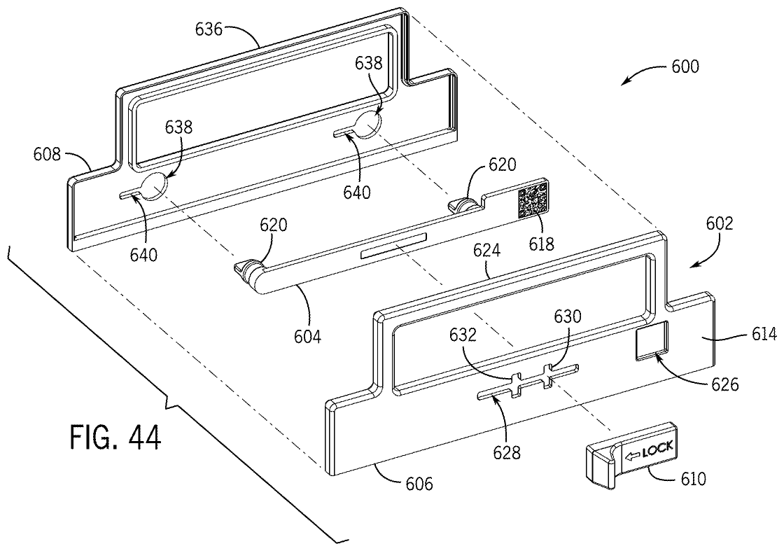

FIGS. 44-47 illustrate a clip 600 according to another example embodiment of the invention. The clip 600 is configured as a tamper-resistant securing device that can engage and secure a container, such as a bag, for example, so that the contents within the bag are unable to be handled when the clip 600 is in a locked orientation and a sealed configuration. The clip 600 includes a housing assembly 602 and a lock member 604. The housing assembly 602 includes a first housing portion 606 and a second housing portion 608. The lock member 604 can be secured to the first housing portion 606 and positioned between the first housing portion 606 and the second housing portion 608. The clip 600 also includes a slide 610 that can be secured to the lock member 604 proximate to an outer surface 614 of the first housing portion 606. In some applications, a slide, such as the slide 610, and a lock member, such as the lock member 604, can be bonded via a variety of securing processes or techniques. For example, a slide can be bonded to a lock member via ultrasonic welding, heating staking, or adhesive bonding.

The lock member 604 includes a unique identifier 618 disposed on an end of the lock member 604. Like the unique identifier 182, the unique identifier 618 may be configured as a QR code. The lock member 604 also includes a pair of tabs 620. The tabs 620 may be configured as breakaway tabs such that twisting or bending the tabs 620 disengages the tabs 620 from the lock member 604. The first housing portion 606 includes a handle 624, a window 626, and a slot 628 having a first stop 630 and a second stop 632. In general, the window 626 provides a degree of visibility from the outer surface 614 of the first housing portion 606 to view the unique identifier 618.

Still referring to FIG. 44, the second housing portion 608 includes a handle 636 and a pair of through holes 638 with narrowed slits 640 extending therefrom. The pair of through holes 638 are dimensioned to receive the corresponding tabs 620. In use, the tabs 620 can be inserted through the second housing portion 608 via the through holes 638. Once the lock member 604 is slid so that the tabs 620 extend at least partially through the slits 640, the tabs cannot pass through the slits 640.

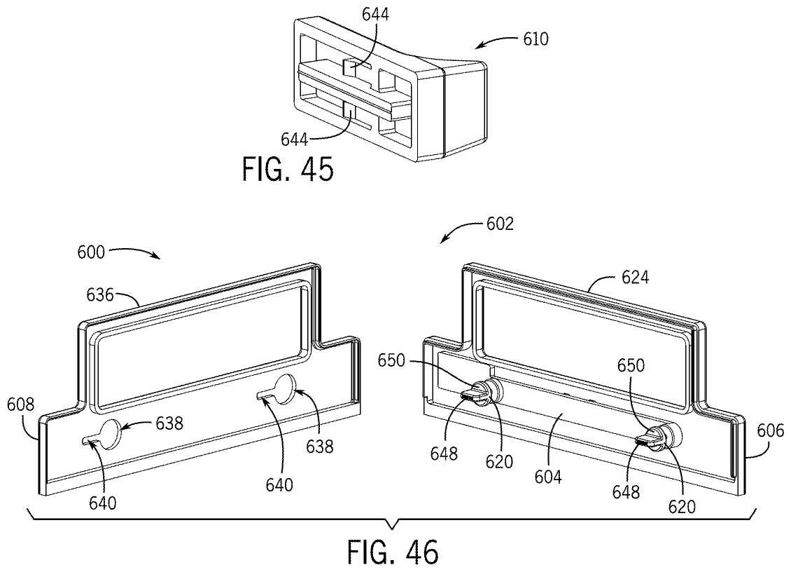

FIG. 45 illustrates an inner side of the slide 610 of the clip 600. The slide 610 includes a pair of teeth 644. The pair of teeth 644 are dimensioned to engage the first stop 630 of the first housing portion 606 when the clip 600 is in the unlocked orientation. Correspondingly, the pair of teeth 644 are dimensioned to engage the second stop 632 of the first housing portion 606 when the clip is in the locked orientation.

In use, by moving the slide 610 from engagement with the first stop 630 to the second stop 632, the lock member 604 is moved within the housing assembly 602 and the tabs 620 are correspondingly moved from extending through the through holes 638 to extending through the slits 640. The shape of the teeth 644 prevent the slide member, and thus, the lock member 604, from being moved from the locked orientation to the unlocked orientation. Therefore, to release the bag from the clip 600 in the locked orientation, the tabs 620 must be broken off so that the lock member 604 and the first housing portion 606 can be separated from the second housing portion 608.

With reference to FIG. 46, the tabs 620 include a grip portion 648 and a disk portion 650. Each of the grip portion 648 and the disk portion 650 are dimensioned to extend and pass through the through holes 638. When the lock member 604 is slid into the locked orientation, each of the grip portion 648 and the disk portion 650 continue to extend through the corresponding slits 640. When the tabs 620 are removed from the lock member 604, the grip portion 648 can be used to separate the disk portion 650 from the lock member 604.

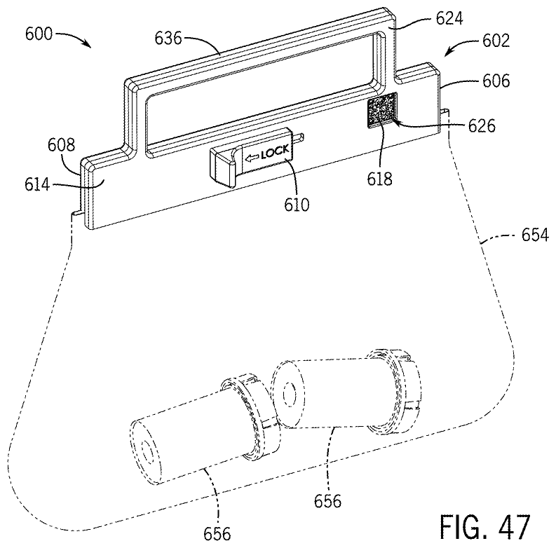

FIG. 47 illustrates an example of the clip 600 in a locked orientation and a sealed configuration secured to a bag 654. Further, by way of example, the bag 654 includes medicine containers 656. As described above, tamper-resistant securing devices, such as the clip 600, can be used to transport a variety of goods, including, food, medicine, pharmaceuticals, and other sensitive goods where confirmation of non-tampered transit may be desired. In use, goods, such as the medicine containers 656 may be placed into the bag 654. The clip 600 may then be secured to the bag to close the opening thereto. In one example, the clip 600 and the bag 654 form a generally contiguous assembly, such that first housing portion 606 is secured (e.g., attached, adhered, co-molded, sonically welded, etc.) proximate one portion of the bag 654 near the opening, and the second housing portion 608 is also secured (e.g., attached, adhered, co-molded, sonically welded, etc.) proximate another portion of the bag 654 near the opening. Once the goods are placed within the bag 654, the first housing portion 606 and the second housing portion 608 may be brought into alignment to form the housing assembly 602. The clip 600 can then be moved from the unlocked orientation to the locked orientation by urging the slide 610 from a first position to a second position to reveal the unique identifier 618. The unique identifier can then be scanned to alert a system or end user that the goods are ready for transit. The unique identifier can then be rescanned at the end of transit to confirm that the clip 600 is still intact and that the medicine containers 656 have not been handled. The tabs 620 can then be removed to unlock and unseal the clip 600 so the user can access the contents of the bag 654.

A variety of manufacturing methods and materials may be used to produce the example clips described herein. Given the benefit of this disclosure, one skilled in the art will appreciate that application-specific requirements may influence the particular manufacturing processes and materials used to implement the clip concepts. For instance, in some applications, the clip components may be generally injection molded from plastic materials that have sufficient material properties to perform the ultimate function. However, other manufacturing methods and techniques are possible. For example, in some applications, the clip components may be produced via additive manufacturing (e.g., 3D printing), metal stamping, overmolding metal inserts, and/or other secondary processes. Such secondary processes can include, for example, ultrasonic welding, heat staking, or adhesive bonding. In some embodiments, a unique identifier, such as those described herein, can be created by laser etching or printing, such as decal, label, or pad printing processes. The concepts described herein are not limited to any particular manufacturing process or material composition.

In some implementations, devices or systems disclosed herein can be utilized, manufactured, or installed using methods embodying aspects of the invention. Correspondingly, description herein of particular features, capabilities, or intended purposes of a device or system is generally intended to inherently include disclosure of a method of using such features for the intended purposes, a method of implementing such capabilities, and a method of manufacturing relevant components of such a device or system (or the device or system as a whole). Similarly, unless otherwise indicated or limited, discussion herein of any method of manufacturing or using a particular device or system is intended to inherently include disclosure, as embodiments of the invention, of the utilized features and implemented capabilities of such device or system.

In this regard, for example, FIG. 48 illustrates a method 700 for securely delivering goods using a tamper-resistant securing device. By way of example, the method 700 will be described below with reference to the clip 100, although other tamper-resistant securing devices (e.g., clip 300, 400, 500, 600) can be used. Operation 702 of the method 700 includes a customer placing an order or a recipient making an order request. In some examples, the order may be placed via an ordering platform (e.g., UBER EATS, DOORDASH, GRUBHUB, etc.).

In general, a platform can be capable of placing, receiving, and/or processing an order and can include hardware such as processors and databases that can provide communication between devices such as, for example a server, a personal computer, a mobile device (e.g., a smart phone, tablet, or cell phone), a personal digital assistant, or any other type of computing device. The platform can also include an interface component that permits a user to enter data and commands into a processor, which in turn can initiate, terminate, or modify an order. As understood by one of ordinary skill when given the benefit of this disclosure, the platform may include relevant frontend and backend hardware and software to implement the method 700, such that additional details of the platform are not included herein.

Operation 704 of method 700 includes the seller or producer or distributor, such as a restaurant, receiving and logging the customer order. At operation 706 of method 700, the seller or provider can prepare the order. At operation 708 of method 700, the seller can package the goods (e.g., a restaurant can place food in to-go packaging). At operation 710 of method 700, the seller can apply a security device, such as the clip 100, to the exterior of the packaging thereby revealing the unique identifier 182. At operation 712 of method 700, the seller can pair or correlate (e.g., scan) the unique identifier code with the ordering platform. For example, a restaurant can pair the unique identifier 182 with the Uber Eats platform. At operation 714 of method 700, the ordering platform can notify a courier of the ordering platform (and the customer) that the order is ready for transit. At operation 716 of method 700, the courier can arrive at a receiving point to pick up the packaged goods. At operation 718 of method 700, the courier can scan the unique identifier 182 thereby taking responsibility for the package. Also at operation 718, the customer may be notified that the package is in transit.

In some embodiments, after operation 708 is complete, operation 716 can occur such that the courier arrives once the goods are prepared and then operation 710 may follow so that the courier applies the security device to the exterior of the packaging. It follows then that operations 712 and 714 occur such that the courier pairs the unique identifier with the delivery platform and the customer is notified that the package is in transit.

Operation 720 of method 700 can occur following transit of the goods. Operation 720 includes the courier for the delivery service arriving at a final destination. At operation 722 of method 700, the courier can pair the unique identifier 182 with the delivery platform thereby finalizing responsibility of transport. At operation 724 of method 700, the customer can confirm the unique identifier 182 and verify package integrity. At operation 726 of method 700, the customer can unlock the clip 100 so that the contents of the package are accessible, and in some forms disfiguring the unique identifier 182.

The discussion herein is presented for a person skilled in the art to make and use embodiments of the invention. Given the benefit of this disclosure, various modifications to the illustrated embodiments will be readily apparent to those skilled in the art, and the generic principles herein can be applied to other embodiments and applications without departing from embodiments of the invention. Thus, embodiments of the invention may be not intended to be limited to embodiments shown, but can be to be accorded the widest scope consistent with the principles and features disclosed herein. The detailed description is to be read with reference to the figures, in which like elements in different figures have like reference numerals. The figures, which may be not necessarily to scale, depict selected embodiments and may be not intended to limit the scope of embodiments of the invention. Skilled artisans will recognize the examples provided herein have many useful alternatives and fall within the scope of embodiments of the invention.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A tamper-resistant securing device for use with a closeable container, the device comprising:
a housing assembly, the housing assembly configured to be movable from a sealed configuration to an unsealed configuration;
a lock member at least partially enclosed within the housing assembly, the lock member configured to be movable between an unlocked orientation and a locked orientation; and
an identifier associated with at least one of the housing assembly and the lock member, and configured to be accessible when the lock member is in the locked orientation;
wherein when the housing assembly is in the sealed configuration and the lock member is in the unlocked orientation, the housing assembly and the lock member are configured to permit the lock member to move from the unlocked orientation to the locked orientation;
wherein when the housing assembly is in the sealed configuration and the lock member is in the locked orientation, the housing assembly and the lock member are configured to inhibit the lock member from moving from the locked orientation to the unlocked orientation; and
wherein when the housing assembly is in the unsealed configuration and the lock member is in the locked orientation, the housing assembly and the lock member are configured to permit the lock member to move from the locked orientation to the unlocked orientation.

2. The tamper-resistant securing device of claim 1, wherein the identifier is not accessible when the lock member is in the unlocked orientation.

3. The tamper-resistant securing device of claim 1, wherein the lock member is slidable relative to the housing assembly.

4. The tamper-resistant securing device of claim 1, wherein:
the lock member includes a recess and the housing assembly includes a tooth; and
the tooth is engaged with the recess when the lock member is in the locked orientation and the housing assembly is in the sealed configuration.

5. The tamper-resistant securing device of claim 4, wherein the tooth is disengaged from the recess when the housing assembly is in the unsealed configuration.

6. The tamper-resistant securing device of claim 1, wherein the identifier is disposed on a proximal end of the lock member.

7. The tamper-resistant securing device of claim 1, wherein the housing assembly includes a handle portion.

8. The tamper-resistant securing device of claim 1, wherein the housing assembly is configured such that the housing assembly is deformed when moved from the sealed configuration to the unsealed configuration.

9. The tamper-resistant securing device of claim 1, wherein:
the housing assembly includes a first housing portion and a seal portion; and
the seal portion is configured to be separated from the first housing portion along lines of material weakness when the housing assembly is moved to the unsealed configuration.

10. The tamper-resistant securing device of claim 1, wherein the lock member includes an actuation portion engageable to move the lock member between the unlocked orientation and the locked orientation.

11. The tamper-resistant securing device of claim 1, wherein the housing assembly includes a first housing portion and a tube, and the lock member includes a tongue that is dimensioned to be received by the tube.

12. A method of selectively securing goods within a container having a closeable opening with a tamper-resistant securing device, the method comprising:
securing the opening of the container via a lock member and a housing assembly of the tamper-resistant securing device;
moving the lock member into a locked orientation to inhibit opening of the container without moving the housing assembly from a sealed configuration to an unsealed configuration; and
revealing an identifier accessible after moving the lock member into the locked orientation.

13. The method of claim 12, wherein moving the lock member into a locked orientation includes sliding the lock member relative to the housing assembly so that a tooth of the housing assembly engages a recess of the lock member and the lock member is prevented from sliding in an opposing direction.

14. The method of claim 12, further comprising scanning the identifier.

15. The method of claim 12, further comprising unsealing a single-use seal portion from the housing assembly to unlock the lock member and access the goods within the container.

16. The method of claim 15, wherein unsealing the single-use seal portion includes pulling the single-use seal portion at a pull tab that extends away from the housing assembly.

17. A method of delivering goods using a tamper-resistant securing device, the method comprising:
receiving an order for a good in a platform;
preparing the order at a preparation site;
inserting the good into a container;
applying a tamper-resistant securing device to an opening of the container;
securing the tamper-resistant securing device in a locked orientation to reveal an identifier; and
pairing the identifier with the platform at the preparation site.

18. The method of claim 17, wherein the pairing the identifier with the platform at the preparation site notifies a courier that the container is ready for transit.

19. The method of claim 17, further comprising:
transporting the container and the tamper-resistant securing device to a receiving site; and
pairing the identifier with the platform at the receiving site.

20. The method of claim 19, wherein pairing the identifier with the platform at the preparation site sends an alert to the receiving site.
